(19) United States
(12) Patent Application Publication
(10) Pub. No.: US 2009/0134995 A1
(43) Pub. Date: May 28, 2009

(54) Workspace enclosure system with automatic shut-off

(75) Inventor: Louis J. Wardlaw, III, Jakarta (ID)

Correspondence Address: Hugh R. Kress;Arnold & Knobloch LLP, Suite 630, 2401 Fountainview, Houston, TX, 77057, US

(73) Assignee: Cinaruco International, S.A.

(21) Appl. No.: 11/986,905

(22) Filed: Nov. 26, 2007

(51) Int. Cl. G08B 21/00

(52) U.S. Cl. 340/532; 340/632

(57) ABSTRACT

An emergency shut off system for a workspace enclosure system, wherein the shutoff system comprises an emergency shut-off module disposed within a workspace enclosure. A plurality of sensors are disposed within the workspace enclosure to detect the presence of undesirable gases or other undesirable conditions within the workspace enclosure. A control module external to the workspace enclosure is coupled to receive output signals from the plurality of sensors, and in response thereto to selective initiate a shut-down of operations taking place within the enclosure. In one example, the control module sends control signals to the emergency shut-off module causing the latter to close one or more valves restricting the flow of gases from external gas supply canisters. A blower is provided to create a flow of air into the enclosure, thereby maintaining a positive pressure within the enclosure. An air intake/sensor module is connected via a closed conduit or the like to the intake of the blower. The intake/sensor module includes a sensor for detecting the presence of gases or other undesirable conditions of incoming air, prior to said air reaching the intake of the blower. The control module is responsive to signals from the sensor in the intake/sensor module to deactivate the blower, thereby preventing undesirable gases to be delivered to the interior of the enclosure. In one embodiment, a baffle is provided within the intake/sensor module for enhancing the effectiveness of the sensing operation by minimizing the amount of incoming air that is not exposed to the sensor prior to being delivered into the enclosure.

### FIELD OF THE INVENTION

The present invention relates generally to enclosures for working environments, and more particularly relates to a system and methodology for avoiding unsafe conditions in and around such enclosures.

### BACKGROUND OF THE INVENTION

There are various settings in which it is necessary or desirable to provide a barrier between a particular working environment and the area surrounding it. Such settings are typically industrial in nature, and a prominent example of such is found on oil and gas drilling facilities, such as offshore platforms, production facilities and the like, in which industrial activities of various sorts regularly occurs in close proximity to areas in which the activity would be considered dangerous, or in which the environment in general is not suited to performing certain activities.

In the case of offshore drilling platforms, it is very common for welding operations to be performed. Welding, of course, involves the generation of extremely high temperatures, flames and/or electrical arcs, sparks and fragments of materials being sprayed in uncontrolled directions. It is obviously not advisable or desirable for such activities to be performed in close proximity to hydrocarbon liquids and gases, which for the most part are highly combustible.

In recognition of these concerns, there has been proposed in the prior art the concept of an enclosure intended to surround a working area and isolate the working area from potentially hazardous external conditions in close proximity to the working area. Examples of such enclosures are proposed, for example, in U.S. Pat. No. 7,193,501 to Albarado et al. entitled “Enclosure System Allowing for Hot Work Within the Vicinity of Flammable and Combustible Material;” in related U.S. Pat. No. 7,091,848 to Albarado, entitled “Enclosure System for Hot Work Within the Vicinity of Flammable or Combustible Material;” in U.S. Pat. No. 6,783,054 to Pregeant, Jr. et al., entitled “System for Controllably Conducting Welding Operations Adjacent Flammable Materials and Method of Welding Adjacent Flammable Materials;” and in related U.S. Pat. Nos. 5,101,604 and 5,018,321 to Wardlaw, III, each being entitled “Subterranean Well Welding Habitat.” Each of the foregoing U.S. Patents are hereby incorporated by reference herein in their respective entireties.

While such work area enclosure systems are known, especially in the oil and gas industry, many implementations do not take into account the potential for the activities or conditions inside the enclosure creating hazardous conditions, such as, for example, if an enclosure contained dangerous concentrations of volatile and/or injurious gases and the like. Such conditions are to be carefully avoided to ensure the safety of persons both inside and outside the working area enclosure.

To address these concerns, there have further been proposed in the art various means for ensuring the safety of persons both within and outside of a workspace enclosure. For example, there has been proposed the provision of sensing devices adapted to signal the presence of combustible or otherwise hazardous conditions within the enclosure. The aforementioned Pregeant, Jr. et al. '054 patent (“Pregeant”), for one, appears to disclose a welding enclosure having one or more sensors for detection of some potentially hazardous condition(s), and for controlling the operations of the welding apparatus in response to signals from the sensor(s).

Notwithstanding the apparent safety benefits arising from the Pregeant disclosure and others in the prior art, there are certain perceived disadvantages to the system proposed in the prior art that make such systems and methods less than optimal in certain respects, and it is believed that there remains an ongoing need for improvements in prior workspace enclosures and the control and safety systems associated with those enclosures.

### SUMMARY OF THE INVENTION

In view of the foregoing, the present invention is directed to a workspace enclosure system including an emergency shut-off mechanism. In one embodiment, the emergency shut-off mechanism comprises an emergency shut-off panel disposed within the workspace enclosure itself. The shut-off mechanism includes solenoid controlled valves for regulating the delivery of welding gases to welding equipment in the enclosure, as well as electrical switching mechanisms for regulating the delivery of welding current from a welding machine disposed outside the enclosure.

In accordance with one aspect of the invention, by disposing the emergency shut-off mechanism within the workspace enclosure, the need to take precautions concerning potential combustion outside of the enclosure due to the activation of solenoid valves or welding current switching circuitry is advantageously eliminated.

In accordance with another aspect of the invention, canisters containing the welding gases can be coupled directly to the emergency shut-off mechanism without the need for equipping the canisters with the necessary valves to control the delivery of welding gases. This means that the system may be implemented with a wider variety of welding equipment without the need for special retrofitting or modification to the welding equipment.

In accordance with another aspect of the invention, an air intake/sensor unit is coupled via a substantially closed air-handling system to the intake of a blower providing air to the interior of the enclosure to maintain a positive pressure therein. Due to the closed nature of the air flow system, it can be assured that any air or gas entering the enclosure will be subjected to analysis by one or more sensors in the intake/sensor unit. That is, no un-analyzed air can be sent into the enclosure.

In one embodiment, the intake/sensor unit is configured with a baffle structure for creating eddy currents within the unit, thereby maximizing the exposure of air passing through the unit to the internal sensor(s).

### BRIEF DESCRIPTION OF THE DRAWINGS

The foregoing and other features and aspects of the present invention will be best appreciated by reference to a detailed description of the specific embodiments of the invention, when read in conjunction with the accompanying drawings, wherein:

FIG. 1 is a block diagram of a prior art workspace enclosure system;

FIG. 2 is a block diagram of a workspace enclosure system in accordance with one embodiment of the invention;

FIG. 3a is an isometric view, and FIG. 3b is a side view, of an intake/sensor module utilized in the embodiment of FIG. 2.

### DETAILED DESCRIPTION OF SPECIFIC EMBODIMENTS OF THE INVENTION

In the disclosure that follows, in the interest of clarity, not all features of actual implementations are described. It will of course be appreciated that in the development of any such actual implementation, as in any such project, numerous engineering and technical decisions must be made to achieve the developers' specific goals and subgoals (e.g., compliance with system and technical constraints), which will vary from one implementation to another. Moreover, attention will necessarily be paid to proper engineering practices for the environment in question. It will be appreciated that such a development effort might be complex and time-consuming, but would nevertheless be a routine undertaking for those of ordinary skill in the relevant fields.

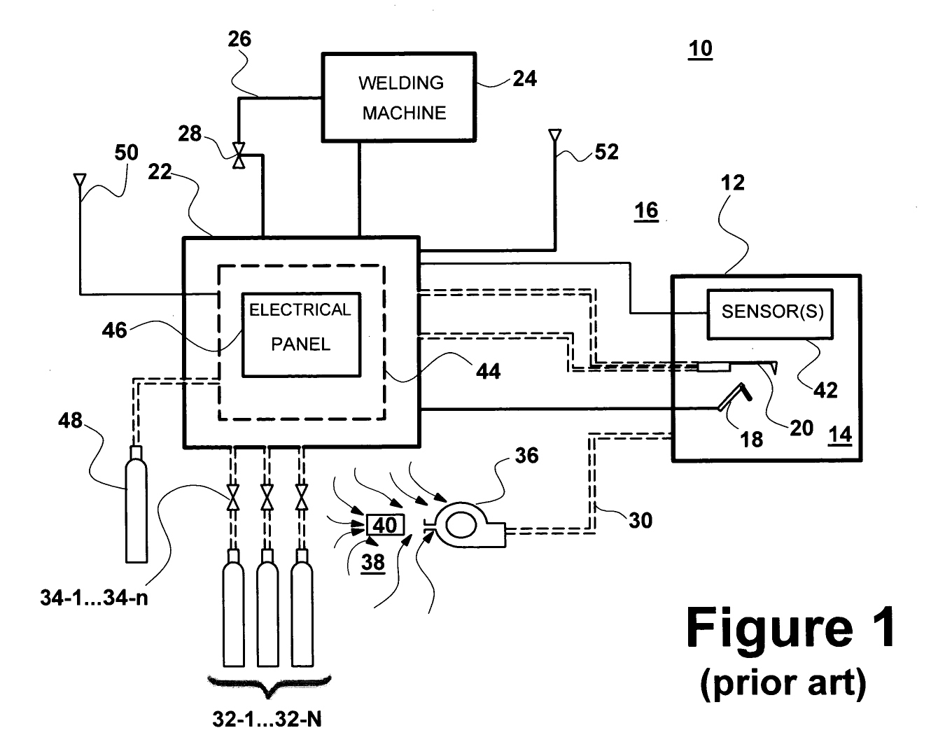

Referring to FIG. 1, there is shown a simplified schematic block diagram of a prior art workspace enclosure system 10 and illustrating certain features and aspects thereof, some of which may be perceived by some to be undesirable or less than optimal. In FIG. 1, a workspace enclosure 12 is provided for establishing a fire-resistant barrier between the interior workspace 14 and the exterior surrounding environment 16. In the prior art, it is most commonly the case that the barrier is constructed of rigid components, such as fire-resistant, treated plywood.

As will be apparent to those of ordinary skill in the art, system 10 is adapted for use both with gas-based (e.g., oxy-acetylene) welding/cutting equipment and with electricity-based (e.g. arc-welding) equipment. (Presently, oxy-acetylene equipment predominates the general class of gas-based welding/cutting equipment, and although the term oxy-acetylene is used throughout this disclosure, it will be apparent to those of ordinary skill in the art that the invention is applicable to any type of gas-based system. Similarly, the term arc-welding is used herein as a general term for any form of electricity-based welding systems, such as are well-known in the art.) System 10 as shown in FIG. 1 shows both gas-based and electricity-based welding equipment, although it is to be understood that under most circumstances, only one type of welding and/or cutting operation will be performed at any one time.

Thus, FIG. 1 includes an exemplary arc-welding apparatus consisting of a welding electrodes 18 as well as an exemplary oxy-acetylene apparatus consisting of a welding/cutting torch 20, each intended to be used within the safety of enclosure 12.

As is further shown in FIG. 1, the system 10 includes a main controller 22 to which various components are attached. In particular, in the case of arc-welding and the like, controller 22 is coupled to a welding machine, which in the disclosed embodiment is a conventional diesel welding machine. As shown in FIG. 1, welding machine 24 is coupled to controller 22 by means of a control line 26 having a solenoid valve 28 in series. In this example embodiment, a control signal sent on control line 26 by controller 22 activates valve 28, which in turn controls the choke of welding machine 24, and in particular, causing welding machine 24 to cease operating.

Welding machine 24 is also coupled to controller 22 by means of power lines 30, upon which the welding current is carried for performance of a welding operation using electrodes 18.

A plurality of gas supply canisters 32-1 . . . 32-n are coupled to controller via hoses having valves 34-1 . . . 34-n which are also solenoid-type valves controlled by controller 22 to permit welding/cutting gases (e.g., oxygen and acetylene) to be supplied to welding torch 20.

As will be known to those of ordinary skill in the art, it is desirable to maintain a positive pressure within enclosure 12, i.e., to ensure that the air pressure within enclosure 12 is some degree greater than the outside air pressure. Among other things, this avoids the build-up of potentially combustible gases within enclosure 12, thereby providing users within the enclosure a measure of safety.

To accomplish this, and in accordance with the prior art, a blower 36 is coupled to enclosure 12 to intake external air 38 and continuously blow the intake are into housing 12.

Optionally, the enclosure 12 may further include an output blower (not shown in FIG. 1) for evacuating air from the enclosure. Preferably, the total volume capacity of any output blower is adjusted to be no greater than the capacity of the intake blower 36, in order to maintain a positive pressure within the enclosure 12.

In accordance with one conventional implementation, there is provided one or more sensors 40 at the intake of blower 36 for detecting the presence of unwanted gases in the air 38 in the vicinity of the blower intake, in order to avoid introducing such gases into the enclosure 12.

In accordance with conventional practice, system 10 further includes at least one, and usually a plurality of sensors 42 disposed within enclosure 12 for detecting the presence of undesirable gases, or undesirable concentrations of gases, and/or other undesirable conditions within enclosure 12 that would pose a danger to workers in the enclosure. The outputs from sensors 42 are electrical signals that are coupled to controller 22.

With continued reference to FIG. 1, controller 22 in a typical prior art implementation either comprises in total, or has defined therein, an interior cavity 44 that houses an electrical panel 46 upon which all electrical connections necessary for operation of the system 10 are made. In one prior art embodiment, interior cavity 44 is infused with a supply of an inert gas from a separate gas canister 48. This ensures that there is no risk of any combustion occurring as a result of the making or breaking of electrical connections by controller 22 even if combustible gases are present in the vicinity of controller 22.

In the operation of system 10, controller 22 receives sensor signals from the various sensors in system 10, and in the event that any undesirable conditions are detected by one or more sensors, controller 22 can immediately shut down the welding/cutting operation by disconnecting or deactivating various components. For example, controller 22 is coupled to valves 34-1 . . . 34-n and is capable of shutting of delivery of welding gases to the torch 20 in enclosure 12. Furthermore, controller 22 can operate to decouple the entire system from its power source 50.

Preferably, controller 22 is also interfaced with a platform shutdown signal 52 such that system 10 can be responsive to platform-wide emergencies or other circumstances in which it is critical to disable all operating equipment on the platform.

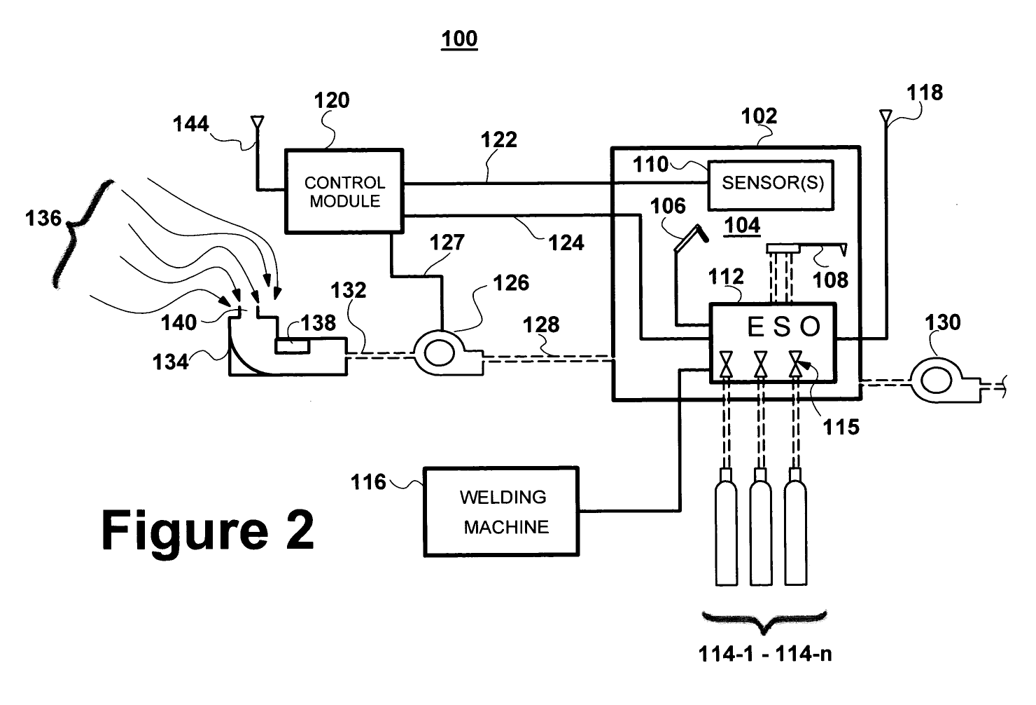

Referring now to FIG. 2, there is shown a workspace enclosure system 100 with emergency shutoff (ESO) functionality in accordance with one embodiment of the invention. System 100 comprises a workspace enclosure 102, which in one embodiment comprises a plurality of individual flexible panels (not individually shown in FIG. 2) fastened together by means of zippers or other suitable means to create a tent-like enclosure. An example of such an enclosure is the Habitat™ Welding Isolation Chamber commercially available from Hot-Hed, Inc. The Habitat™ is a portable, inflatable structure specifically designed to facilitate field welding. It is designed to be utilized, among other environments, on off-shore platforms and eliminates the need for costly, time-consuming shut-downs.

In a preferred embodiment, the workspace enclosure's flexible (e.g., fabric) walls expand to suit the available space on the platform and isolate a welding area, safely containing the heat-source by maintaining a positive air-pressure within. The size of any given enclosure can be customized due to the modular nature of the enclosure's components. The positive-pressure system works in the same way as that of the accommodation block on an off-shore platform by creating a virtual air-lock within the enclosure and is maintained by means of continuous air-flow input and extraction, as is known in the art. A ratio on the order of 2:1 input to extraction has been found to be sufficient to ensure that the enclosure is inflated at all times and that the air inside is always clean and free of outside contaminants.

In one embodiment, the enclosure's floor and walls are manufactured from a light-weight, heat-resistant fabric which confines sparks and splatters. Custom-built sleeves adapted to slip easily over pipes and around beams to create a seal are preferably provided.

The enclosure is adapted to be installed around or over a workspace area to be secured and inflated using a blower which applies an air-input of between 700 and 1200 CFM and a positive pressure of between 10 and 20 Pascals. Optionally, an additional exhaust blower provides positive pressure and constant air circulation inside the welding chamber. Such blowers are available as air or electrically-driven units and can be located away from the enclosure itself. In one embodiment, workspace enclosure 102 may be assembled within and held upright by means of an external scaffolding structure or the like, or may have certain key portions of the enclosure tied or otherwise secured to existing structures in the workspace environment.

The flexible and modular nature of an enclosure structure in accordance with the present invention is that a workspace enclosure can be more readily established in areas with uneven floors or other surfaces than would a completely rigid (e.g., plywood or the like) enclosures.

In another variant of the invention, a modular portion of the fabric comprising the enclosure is replaced with a rigid access panel (e.g., an access panel including a frame and a securable door capable of being opened by persons both within and without the enclosure.) promoting ease of entry and exit into and from the enclosure 102. The modular nature of enclosure 102 in the preferred embodiment easily lends itself to such an option, as would be appreciated by those of ordinary skill in the art.

Enclosure 102 defines an enclosed workspace 104 containing electricity-based welding electrodes 106 and/or a gas-based welding/cutting torch 108, as described above with reference to FIG. 1. Further, enclosure 102 contains one or more sensors 110, similar to sensors 42 in FIG. 1, for detecting the presence of certain gases or other undesirable conditions within the enclosure 102, as is also described above with reference to FIG. 1.

In accordance with one aspect of the invention, in the embodiment of FIG. 2, an emergency shutoff (ESO) module 112 is contained within enclosure 102, and has connections to welding electrodes 106 as well as to welding torch 108. ESO module 112 also receives, via respective electrical cables and gas lines, welding gases from welding gas canisters 114-1 - 114-n disposed outside of enclosure 102, with solenoid controlled valves 115 being subject to control by control module 120. ESO module 112 also receives the welding electricity from a welding machine 116 also disposed outside enclosure 102. Finally, ESO module 112 receives an external source of power 118. In one embodiment of the invention, the source of power 118 may be welding machine 116. This advantageously minimizes the extent to which an operator of the enclosure must rely on existing on-site facilities, inasmuch as it reduces the number of connections to the on-site infrastructure to merely a platform shutdown connection 144, a signal generated by the operator of the platform or other facility in critical situations where a complete shut-down of all functions is desired.

It is to be noted that in prior art systems, such as that described with reference to FIG. 1, utilizing the welding machine as the source 118 of operating power is not an option. This is because in most prior art systems, a controller is interposed between the welding machine and the welding equipment, such that the system would completely lose operational power when critical conditions are sensed. In the presently disclosed embodiment of the invention, activation of the platform shutdown signal causes control module 120 to simply power down close all solenoid valves. As shown in FIG. 2, the platform shutdown signal 144 is also supplied to blower 126, which is responsive to activation of the shutdown signal to stop. These responses leave the control and sensing functions continuously powered on upon shutdown for any reason, even a platform-wide shut down.

As shown in FIG. 2, a connection 127 between control module 120 and blower 126 enables the control module to shut down blower 126 upon detection of conditions of concern by sensor 138. This advantageously avoids the delivery of potentially hazardous air into enclosure 102.

As shown in FIG. 2, sensors 110 are coupled such as by means of a cable 122 or the like to a control module 120 external to enclosure 102 and provides signals indicative of acceptable and/or unacceptable sensed conditions within enclosure. Module 120 is also electrically coupled via cable or the like 124 to the ESO module 112, in order for monitor 120 to be capable of issuing control signals and commands to the ESO module 112 as will be described hereinbelow.

As in the prior art, such as described with reference to FIG. 1, it is desirable in the presently disclosed embodiment of the invention to maintain a positive pressure in workspace 104 to prevent accumulation of undesirable gases within enclosure 102. To this end, a blower 126 is coupled either directly or via a duct 128 or the like to the interior 104 of enclosure 102, to provide an input airflow into workspace 104. As in the previously described system, an output blower 130 is preferably provided, as shown in FIG. 2, to direct the outflow of air and gases from workspace 104, so long as the relative capacities of blowers 126 and 130 are such that a positive pressure is maintained within enclosure 102, as would be appreciated by those of ordinary skill in the art, and as noted above.

In accordance with one aspect of the invention, the intake of blower 126 is coupled either directly or via ductwork 132 or any other substantially closed means of containing and directing the flow of gases to the output of an intake sensor module 134 which is adapted to steer incoming air 136 past an intake sensor 138 as the air 136 is drawn in due to the suction force of blower 126.

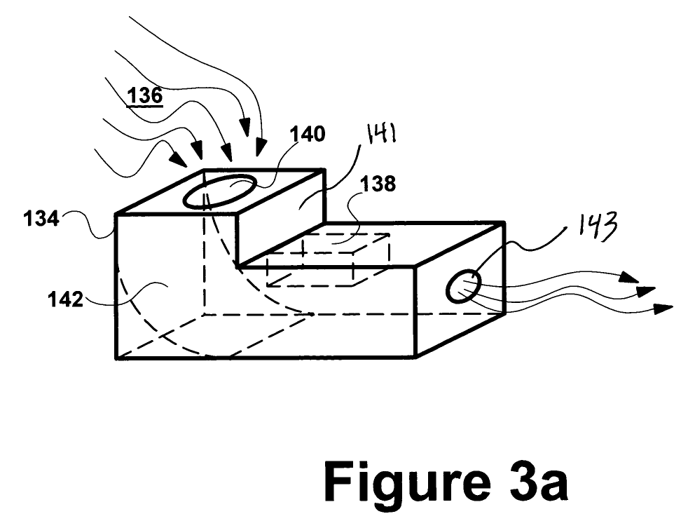

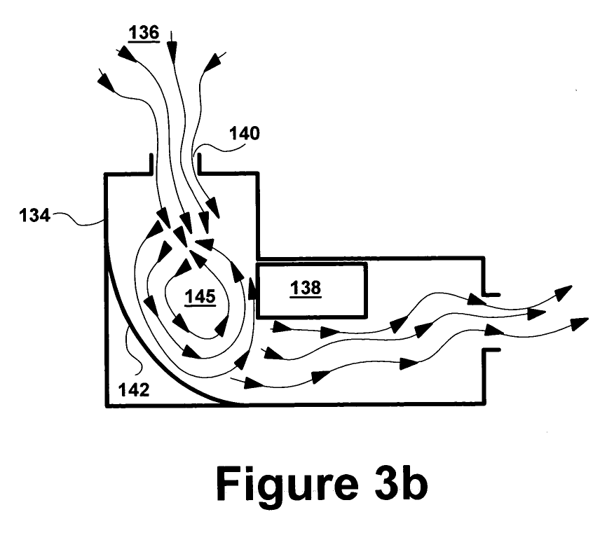

With reference to FIGS. 3a and 3b, in a presently preferred embodiment of the invention, air intake sensor module 134 comprises a substantially rectangular hollow body, and includes an intake port feature 140 for permitting entry of air 136 from the exterior environment into the intake sensor module 134. As shown in FIGS. 3a and 3b, intake port feature 140 may take the form of an aperture in a generally rectangular feature 141 projecting upward from the upper surface of the substantially rectangular hollow body, and offsetting the intake port aperture from the remainder of the upper surface of the substantially hollow body. An internal baffle structure 142 is provided generally beneath the intake 140 as shown in FIGS. 3a and 3b. Baffle 142 is provided in order to induce eddy currents (designated generally with reference numeral 145 in FIGS. 3a and 3b) in the vicinity of a sensor 138 that is disposed within the substantially hollow rectangular body. The creation of eddy currents 145 tends to maximize the exposure of sensor 138 to the incoming air 136. After entry into intake/sensor module 126, the airflow occurs within a closed system (e.g., flexible ductwork), such that air that has been drawn past sensor 138 is expelled from an output port 143 disposed on a front end of the substantially rectangular hollow body of intake sensor module 134 and delivered to the intake of a blower 126, as herein described.

It is believed that the arrangement of blower 126 and intake/sensor module 134 offers advantages over the prior art, such as the prior art described herein with reference to FIG. 1, inasmuch as in accordance with one aspect of the present invention, the closed system ensures to a considerably greater degree that air introduced into enclosure 102 via blower 126 and conduit 128 has been subjected to sensing by sensor 138, whereas in the prior art, such as shown in FIG. 1, it is likely that a substantial fraction of the air entering blower 36 does so without passing sufficiently within the proximity of sensor 40 to provide a sensitive and accurate analysis.

With continued reference to FIG. 2, the emergency shutoff (ESO) module 112 disposed within enclosure 102 in addition to serving as a manifold for the incoming welding gases from canisters 114-1-114-n and providing the gases to torch 108, is also coupled to welding machine 116 to receive the welding current that is provided to electrodes 106 in the case of electricity-based welding operations. Thus, all of the critical electrical connections in system 100 are made within enclosure 102 itself, which is by design a controlled environment kept free of undesirable combustible gases. Accordingly, no separate inert gas supply is required to insulate the electrical panel of the embodiment of FIG. 2, in contrast to the prior art system of FIG. 1, in which the electrical panel is disposed outside of the enclosure and hence requires a dedicates source of inert gas to avoid combustion arising from sparks and/or electrical arcing occurring during operation of the system.

As would be appreciated by those of ordinary skill in the art, elimination of the need for a dedicated inert gas canister has the advantage of simplifying the system as a whole, reducing the number of components making up the system and hence reducing not only the costs of creating and operating the system, but also the amount of space occupied by the system as a whole. It is widely understood that in environments such as drilling platforms and the like, all space is at a premium, and any reduction in the size of operating equipment is considered highly desirable.

In FIG. 2, it is shown that system 100, in particular, monitor 120, is coupled to a platform shutdown connection 144, just as is controller 22 in the prior art. As would be understood by those of ordinary skill, this connection provides a means by which system 100 can be immediately and completely disabled in the event of a serious event occurring outside of system 100, such as on a drilling platform or the like.

As described herein, the presently preferred embodiment of the invention is believed to offer several significant advantages over prior art systems. These advantages may not be immediately evident even to those of ordinary skill in the art, but they include, without limitation:
Elimination of need for gas supply to electrical panel. As described herein, the presently preferred embodiment places all of the critical electrical switching and connectivity functions within a shut-off module disposed inside the workspace enclosure, where the gaseous environment is assuredly free of combustible gases. It would be evident to those of ordinary skill that elimination of an extra gas canister is desirable in terms of complexity, risk of malfunction or improper installation, cost, and space, at a minimum.
Providing a closed air handling system between the point of analysis of air being conveyed into the workspace enclosure and the entry of the air into the enclosure. This ensures or at least maximizes the probability that all incoming air/gas is subjected to effective analysis.
In addition to the closed air-handling path noted above, the provision of a intake/sensor module represents an improvement over the prior art, particularly when the intake/sensor module includes a baffle or other means for maximizing the exposure of incoming air/gases to the appropriate sensing mechanism, thereby ensuring a higher degree of safety.
Direct connection of welding gases to the associated welding equipment. In prior art systems, welding gases are directed first through an external controller/manifold before being supplied to the welding equipment contained within the workspace enclosure. This is necessary in order to enable the controller to control the gas flow (as with solenoid valves). Yet such an arrangement requires lengths of gas hoses in which the presence of gases cannot be avoided, even upon a shut-off condition. In accordance with one aspect of the invention, the control solenoids are contained within the ESO module within the workspace enclosure, thereby reducing volumes of uncontrolled gases. Furthermore, in the prior art, standard gas canisters must be fitted with the necessary control valves before being coupled to the system, whereas in accordance with the present invention, no modification of the gas canisters is required.

Although specific embodiments and variants of the invention have been described herein in some detail, it is to be understood that this has been done solely for the purposes of illustrating various features and aspects of the invention, and is not intended to be limiting with respect to the scope of the invention, as defined in the claims. It is contemplated and to be understood that various substitutions, alterations, and/or modifications, including such implementation variants and options as may have been specifically noted or suggested herein, may be made to the disclosed embodiment of the invention without departing from the spirit or scope of the invention.

What is claimed is:

1. A workspace enclosure system, comprising:
a substantially enclosed chamber defining an interior workspace;
a plurality of sensors disposed within said interior workspace for detecting the presence of gases and other undesirable conditions within the workspace;
an emergency shut-off module, disposed within the workspace and responsive to signals from one or more of said plurality of sensors to selectively deactivate operations being performed within the workspace.

2. A workspace enclosure system in accordance with claim 1, further comprising a blower, external to said interior workspace, said blower having an output in communication with an input port of said chamber for creating a flow of air into said chamber.

3. A workspace enclosure system in accordance with claim 2, wherein said blower has an intake port for drawing in air to be blown into said chamber.

4. A workspace enclosure system in accordance with claim 3, further comprising an intake/sensor module, coupled by a substantially closed air conduit to said intake port of said blower, said intake sensor module having at least one sensor disposed therein for analyzing the condition of air drawn in to the intake/sensor module prior to said air being blown into said chamber.

5. A workspace enclosure system in accordance with claim 1, wherein said emergency shut-off module is adapted to receive welding gases from canisters disposed outside said chamber, said emergency shut-off module including at least one valve for controlling the delivery of said welding gases to welding equipment operated within said workspace.

6. A workspace enclosure system in accordance with claim 5, wherein said emergency shut-off module is adapted to receive welding current from a welding machine disposed outside of said chamber, said emergency shut-off module including an electrical panel for selectively controlling the delivery of welding current to welding electrodes operated within the workspace.

7. An air intake and sensor module comprising:
an outer hollow substantially rectangular body, having an intake port feature on a top face thereof and an output port on a front end thereof;
a sensor disposed within said body for detecting at least one gas present in air entering said intake port feature;
an output port on a front end of said substantially rectangular hollow body;
a baffle, disposed within said module and adapted to establish currents in air traveling through said module, thereby improving exposure of said air entering said intake port feature to said sensor.

8. A method of establishing an enclosure around a workspace, comprising:
erecting a substantially enclosed chamber defining an interior workspace;
disposing a plurality of sensors within said interior workspace for detecting the presence of gases and other undesirable conditions within the workspace;
coupling said plurality of sensors to an emergency shut-off module, disposed within the workspace, said emergency shut-off module being responsive to signals from one or more of said plurality of sensors to selectively deactivate operations being performed within the workspace.

9. A method in accordance with claim 8, further comprising attaching a blower, external to said interior workspace, for creating a flow of air into said chamber, thereby maintaining a positive pressure within said chamber.

10. A method in accordance with claim 9, further comprising drawing air into an intake port of said blower.

11. A method in accordance with claim 10, further comprising providing an intake/sensor module, coupled by a substantially closed air conduit to said intake port of said blower, said intake sensor module having at least one sensor disposed therein for analyzing the condition of air drawn in to the intake/sensor module prior to said air being blown into said chamber.

12. A method in accordance with claim 8, further comprising receiving welding gases from canisters disposed outside said chamber, wherein said emergency shut-off module includes at least one valve for controlling the delivery of said welding gases to welding equipment operated within said workspace.

13. A method in accordance with claim 12, further comprising selectively controlling the delivery of welding current to welding electrodes operated within the workspace.
